(19) United States
(12) Patent Application Publication
(10) Pub. No.: US 2002/0116237 A1
(43) Pub. Date: Aug. 22, 2002

(54) Cross-selling optimizer

(76) Inventors: Marc-David Cohen, Hillsborough, NC (US); Judith Tyler Parks, Cary, NC (US)

Correspondence Address: John V. Biernacki, Jones Day, Reavis & Pogue, North Point, 901 Lakeside Avenue, Cleveland, OH, 44114, US

(21) Appl. No.: 09/740,091

(22) Filed: Dec. 18, 2000

Related U.S. Application Data
(60) Provisional application No. 60/207,609, filed on May 26, 2000.

(51) Int. Cl. G06F 17/60

(52) U.S. Cl. 705/7; 705/26

(57) ABSTRACT

A cross-selling optimization method and system for allocating marketing and selling effort in the cross-selling environment. The computer-implemented method and system optimally allocates resources based on results from data warehousing and data mining methodologies. These methodologies form the basis for collecting information for understanding customer relationships and potential market growth. The method and system preferably uses linear programming to determine the optimal way in which to allocate limited cross-selling resources to marketing various products so that the highest possible return on one's marketing investment (ROI) is achieved. The optimal allocations are quantified through one or more cross-selling opportunities metrics (e.g., the optimal amounts of cross-selling effort to achieve the highest possible ROI).

### RELATED APPLICATION

This application claims priority to U.S. provisional application Serial No. 60/207,609 entitled CROSS SELLING OPTIMIZER filed May 26, 2000. By this reference, the full disclosure, including the drawings, of U.S. provisional application Serial No. 60/207,609 are incorporated herein.

### BACKGROUND OF THE INVENTION

1. Technical Field

The present invention is generally directed to computer-implemented sales data analysis, and more specifically to computer-implemented marketing and selling efforts optimization.

2. Description of the Related Art

Previous Customer Relationship Management (CRM) solutions involve a combination of data warehousing and data mining. These components form the basis for collecting information for understanding customer relationships and potential market growth. Identifying cross-selling opportunities is an important goal of the CRM solution. One way this is done in CRM is with market basket analysis. Based on the principles of market basket analysis, the association node in a data miner (such as the data miner “Enterprise Miner” available from SAS Institute Inc.) produces rules data that show cross-selling opportunities. However, the rules do not show which of these opportunities is best in meeting overall business goals nor do they show how to distribute resources to achieve those business goals.

For example, the rules data may contain an association rule such as “CKING→SVG & CCRD” with a statistical “lift” value of 1.1. This is often interpreted to mean that the population that only has purchased a check product (“CKING”) has some potential, of strength 1.1, to purchase savings accounts and credit card products (respectively, “SVG” and “CCRD”). While of value in identifying specific customer populations' potential, the solution gives no suggestion as to whether this or any other rule should be used as a basis for expansion of just the savings account market. Moreover, if this rule is used as a basis for allocating resources it does not show how that decision will impact the target for the CCRD market and whether exploiting this rule is a good overall use of limited resources. Thus, the present approach has difficulty in addressing such business problems as: How can I best allocate limited resources to exploit cross-selling opportunities that meet my overall product sales goals?

### SUMMARY OF THE INVENTION

A cross-selling optimization (CSO) method and system are provided for allocating marketing and selling effort in the cross-selling environment. It addresses the problem of optimizing cross-selling efforts as well as other problems in the previous approaches. It optimally allocates resources based on results from data warehousing and data mining methodologies. These methodologies form the basis for collecting information for understanding customer relationships and potential market growth. The present invention preferably uses linear programming to determine the optimal way in which to allocate limited cross-selling resources to marketing various products so that the highest possible return on one's marketing investment (ROI) is achieved.

### BRIEF DESCRIPTION OF THE DRAWINGS

The present invention satisfies the general needs noted above and provides many advantages, as will become apparent from the following description when read in conjunction with the accompanying drawings, wherein:

FIG. 1 is a block diagram depicting the module structure and data flow of the present invention;

FIG. 2 is a table depicting an exemplary association rule dataset;

FIG. 3 is a table depicting an exemplary subset association rules dataset as generated by the present invention;

FIG. 4 is a pie chart that graphically depicts the exemplary subset association rules dataset of FIG. 3;

FIG. 5 is a table depicting how the effort applied to the targeted populations of FIG. 3 translates into effort applied to products; and

FIG. 6 is a bar chart that graphically depicts the tabular values of FIG. 5.

### DETAILED DESCRIPTION

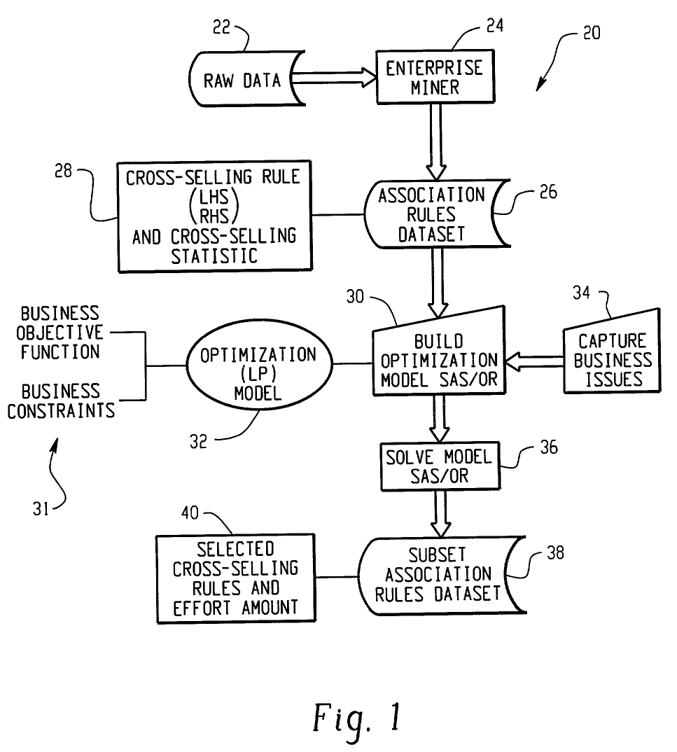

FIG. 1 depicts the cross-selling optimization system of the present invention as generally shown by reference numeral 20. The cross-selling optimization system 20 generates subset association rules 38 based upon raw data 22 that has been pre-processed by a data miner 24. The cross-selling optimization system 20 includes an optimization model 32 (e.g., a linear programming model) to generate the subset association rules 38.

The subset association rules dataset 38 addresses one or more business issues by associating cross-selling rules with metrics that solve the business issues. For example, a business issue may address where should a business allocate its limited personnel efforts so as to optimize its overall return on investment. The present invention provides in subset association rules dataset 38 what amount of effort should be allocated to each cross-selling opportunity so as to optimize the overall return on investment.

First, the present invention may use a data miner 24 to process raw data 22. Raw data 22 may include historical data on the product sales of the business. An exemplary data miner 22 is Enterprise Miner™ available from the SAS Institute Inc. of Cary, North Carolina. Enterprise Miner™ processes the raw data according to known techniques to generate association rules data set 26.

The association rules dataset 26 contains variables such as a rule and at least one cross-selling statistic as shown by box 28. The rules variable, for example, lists products on the left-hand-side of the arrow and products on the right-hand-side. Thus, each record in the dataset is a new rule that elucidates a unique customer group or segment. In addition, each record provides at least one cross-selling statistic to convey information on the likelihood of selling the right-hand-side products to customers who have the left-hand-side products. These statistics or metrics are calculated from raw data 22.

Statistics for this may include the lift and the expected confidence. The lift is the ratio of the probability of having the right-hand-side product(s) given that the customer has the left-hand-side product(s), over the probability that the customer has the right-hand-side product(s). Thus, a large value of lift indicates that the percentage of population with the left-hand-side product(s) is relatively small compared to the strength of the relationship between the right-hand-side and left-hand-side product(s). Other cross-selling statistical metrics may be used in combination with the lift variable to convey additional information on a cross-selling likelihood. For example, the E_Confidence variable may be used with the lift variable to indicate the frequency with which the right-hand-side product occurs in the overall population.

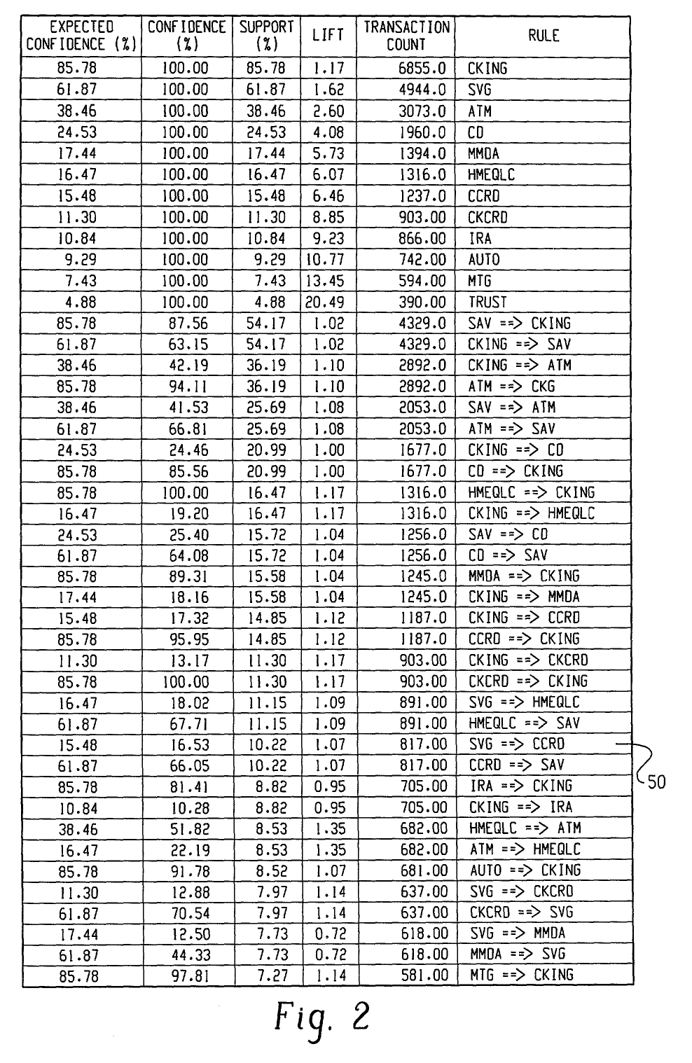

FIG. 2 shows a sample of the association rules dataset 26 where each row reflects a different product combination. For example, row 50 shows that if a person buys a saving accounts product, then the person is likely to purchase credit card products since the lift value is greater than 1. For the products listed in FIG. 2, the following list provides what product a symbol denotes:

| Symbol | Product |
|---|---|
| ATM | Automatic teller machine |
| AUTO | Auto loan |
| CCRD | Credit card |
| CD | Certification of deposit |
| CKCRD | Check card |
| CKING | Checking Account |
| HMEQLC | Home equity loan |
| IRA | Individual retirement account |
| MMDA | Money market certificate |
| SVG | Savings Account |

The raw dataset 22 is analyzed by the association's node in Enterprise Miner™, which generates association rules dataset 26. One technique to determine these rules is by counting the number of customers in the database that have the different combinations of products. Analysts may use these totals to make inferences about the likelihood of successfully selling new products to existing customers. In this way the rules identify cross-selling opportunities. However, the rules do not show which of these opportunities is best in meeting one or more overall business goals, nor do they show how to distribute resources to achieve those business goals while maintaining a high return on investment.

The present invention addresses these problems by capturing business issues 34 in an optimization model 32. Business issues 34 may be external resource goals or effort targets for each individual product. Resources can be measured in many different ways such as dollars, people, and person-hours. To model or represent this effort resource, one assumes that there is one (1) unit resource available (this is 100% selling effort). One also assumes that there are target effort levels for each individual product. That is, a target percentage of effort to spend on selling each product is known.

Box 30 represents the construction of an optimization model 32 based upon the captured business issues of box 34. The optimization model 32 may be a linear program model or some other type of optimization program, such as a non-linear optimization program. The model includes a business objective function and a set of business constraints as shown by reference numeral 31. The business constraints may be stored in data structures that are accessible through any conventional computer storage memory devices.

The business objective function drives the calculation of optimal amount of effort, and the constraints capture the various business issues 34. For example, an objective may be to distribute 100% selling effort across the multitude of cross-selling opportunities so that the weighted average of the product of lift and potential revenue is maximized. This average is weighted by the effort. The optimization model 32 may also have as input: user supplied parameters such as the product effort target levels, the anticipated returns from selling to different customer groups, and maximum acceptable average expected confidence.

Box 36 shows the model being solved using SAS/OR®. SAS/OR® is a comprehensive set of enterprise decision-making tools available from the SAS Institute Inc. The solution is a vector of efforts to be applied to the different customer groups. More specifically, the solution is the subset association rules dataset 38. Dataset 38 contains a subset of association rules together with optimal amounts of effort resources to expend.

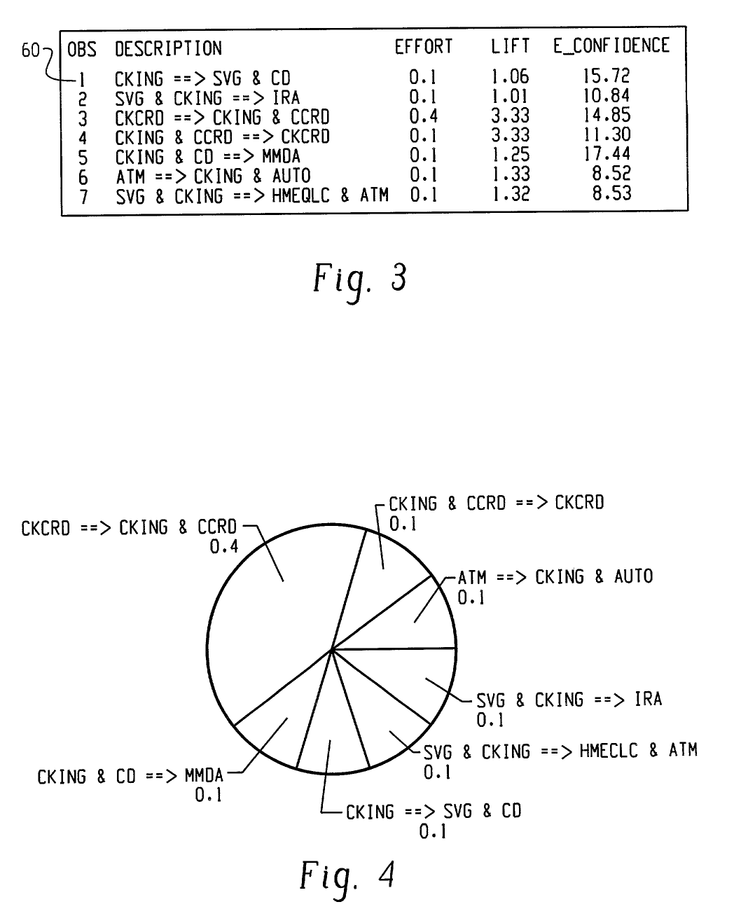

An example of the subset association rules dataset 38 is shown in FIG. 3. Each row of the dataset indicates a product on which it would be useful for the business to expend its cross-selling resources. The different columns show various unique customer groups or segments (represented by unique combinations of products), optimal amounts of resource to expend marketing each individual product, and the actual product(s) to be marketed. For example, row 60 includes the cross-selling opportunities metric of “Effort” to illustrate that it is optimal to allocate 10% of one's resources (e.g., 10% of the marketing budget) towards marketing savings accounts and CD products to the customer segment that holds only checking accounts.

In building the model at box 30, certain assumptions are defined. As an example, we may assume that there is a limited amount of resource to expend on product marketing and selling. This is termed the resource effort, and it is assumed that there is one (1) unit available (this is 100% selling effort). It is also assumed that there are target effort levels for each individual product. That is, we know a target percentage of effort to spend on selling each product. Note that effort can be measured in many different kinds of units. It could be dollars, people, or person hours. For example, you as a marketing director may have a budget of $4 million dollars to spend on product marketing and selling. This $4 million dollars represents 100% effort resource. In addition, you may have a specific product effort target in that you want to spend $500,000 marketing IRAs.

Thus, the business problem in this example is posed as, on which customer groups should you focus your selling efforts in order to meet your targets for each product and, at the same time, maximize the return on your effort investment? This is called the objective. The solution answers this by identifying the amount of effort to use on each customer group. The solution also meets the product sales targets while maximizing the return on the investment.

Information about the size of the potential markets is incorporated implicitly in the objective through the lift. Since this is accounted for implicitly, the solution may recommend significant effort for customer groups simply because they have a large likelihood of success even though they do not represent a large market. To provide some control on this, a constraint is added that limits the average expected confidence weighted by effort to be less than a user supplied quantity.

In this example, there are three types of constraints. One constraint specifies that the total amount of effort is 1. This defines the limited resources available for selling. Another restricts the average of expected confidence weighted by effort. This biases the effort towards customer populations that have greater growth potential. Finally, there is a set of constraints that requires a certain amount of effort be allocated to each product.

The model can be specified unambiguously as follows. Let

J=set of products j

I=set of rules i

$${a}_{ij} = \{ \begin{matrix}1 & if rule i has product j as a result \\ 0 & \end{matrix}$$

Tⱼ=target effort for product j

rᵢ=return from rule i if 100% effort is applied

lᵢ=lift from rule i

cᵢ=expected confidence of rule i

C=maximum expected confidence for the weighted average effort allocation

xᵢ=effort to apply to rule i

All of these quantities are known input parameters except for the effort xᵢ. This is the quantity that is to be calculated by the system and is called the decision variable.

Formal specification has the objective as

$$Max {\sum }_{i ∈ I} {r}_{i} {l}_{i} {x}_{i}$$

and the constraints as:

$$\begin{matrix}{\sum }_{i ∈ I} {a}_{ij} {x}_{i} \geq {T}_{j} ∀ j ∈ J & Target product efforts \\ {\sum }_{i ∈ I} {x}_{i} = 1 & 100 \% effort available \\ {\sum }_{i ∈ I} {c}_{i} {x}_{i} \leq C & Confidence limit \\ {x}_{i} \geq 0 ∀ i ∈ I & Nonnegative effort\end{matrix}$$

xₜ≧0 ∀iεI Nonnegative effort

This example has assumed that the product targets, Tⱼ, are identical for all the products and that the returns, rᵢ, are 1 for each rule in the data set. The present invention uses a software macro that has three arguments: “ds=” which is the name of the rules data set; “conf=” which is the value for the limit on the weighted average expected confidence; and “target=” which is the target effort level for each of the products. The macro call looks like:

%CSO(ds=,conf=,target=);

The following example illustrates the present invention. The macro is called with an expected confidence level of 25 and an effort target of 10% for each of the 10 products that appear on the right-hand-side of at least one rule in the data set.

%CSO(ds=crm.rules,conf=25,target=0.1);

The macro solves the problem by finding the distribution of effort that meets the constraints discussed above and maximizes the total lift weighted by effort (since the returns rₜ are all 1) using known linear programming techniques.

FIG. 3 depicts in a table format the solution. The present invention has selected those customer populations that should be marketed or sold to. It shows the amount of effort to be applied to each of these targeted populations. The present invention picked populations that tend to have larger lift as we would expect, because of the objective. Also, it should be noted that most of the populations have effort 0.1, except for “CKING & CCRD→CKCRD” which has effort 0.4. Most likely this group is selected because of its high lift and low expected confidence. In general, the present invention picks populations that have small expected confidence because of the constraint limiting the weighted average expected confidence to 25. FIG. 4 depicts graphically in a pie chart format the tabular results of FIG. 3.

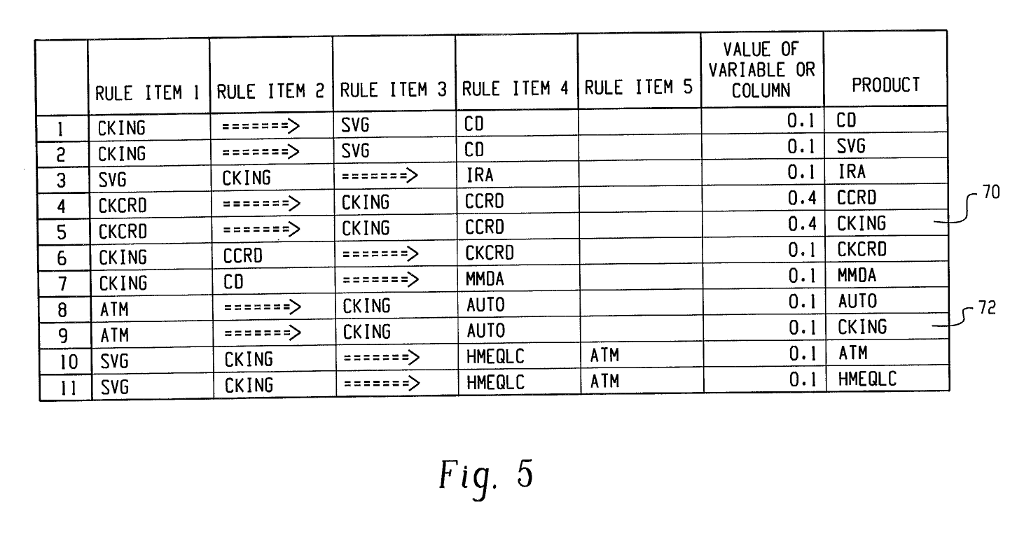

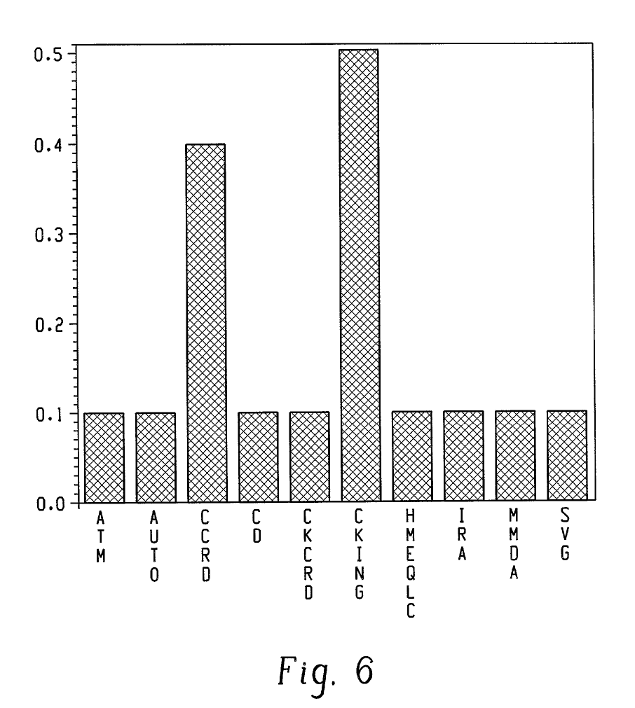

FIG. 5 depicts in a tabular format how the effort applied to these targeted populations translates into effort applied to products. Note that each product has at least 0.1 effort as is required by the business objectives. Note that the CKING product has a total effort of 0.5 due to its combined values of 0.4 and 0.1 as shown respectively at rows 70 and 72. FIG. 6 is a bar chart representation of FIG. 5.

The preferred embodiment described with reference to the drawing figures and associated tables is presented only to demonstrate examples of the present invention. Additional and/or alternative embodiments of the present invention should be apparent to one of ordinary skill in the art upon reading this disclosure. For example, alternative elements or steps that may be included in the present invention include: a constraint that seeks to ensure even dispersion of effort throughout all products; and a constraint that ensures a respectable return on equity. These constraints address such additional business issues as an organization being more interested in maintaining a certain level of shareholder value by avoiding inadequately performing products, rather than maintaining a diverse market of products. As a further example of the broad range of alternate embodiments, a performance measure other than the lift may be used as a measure of potential of the customer population. This may include using the lift factor divided by the maximum lift over all products, as a relative measure of potential.

The present invention also can be used to analyze cross-selling efforts on a regional basis. In this situation, the association rules and statistics would include geographical information in order to determine what are the optimal effort allocations on a per region basis. Still further, the present invention analyzes cross-selling efforts involving items other than products, such as the sale of services.

It is claimed:

1. A computer-implemented method to solve a business issue related to cross-selling opportunities, comprising the steps of:
retrieving cross-selling relationships that associate purchases of a first set of items with purchases of a second set of items;
said cross-selling relationships being associated with a cross-selling statistic, wherein the cross-selling statistic is indicative of potential for the purchase of the second set of items based upon the purchase of the first set of items; and
determining a cross-selling opportunities metric that solves the business issue,
wherein the cross-selling opportunities metric is determined for at least one cross-selling relationship by at least substantially optimizing an objective function with respect to constraints and to the cross-selling statistic, wherein at least one of the constraints is based upon the business issue.

2. The method of claim 1 wherein the objective function is solved for resource allocation related to the purchase of the second set of items using linear programming optimization.

3. The method of claim 2 wherein the objective function is solved for personnel effort resource allocation related to the purchase of the second set of items using linear programming optimization.

4. The method of claim 2 wherein one of the constraints is based upon target effort for an item.

5. The method of claim 2 wherein one of the constraints is directed to size of markets involving the first and second sets of items.

6. The method of claim 2 wherein one of the constraints is directed to size of markets involving the first and second sets of items such that resource allocation is biased towards markets that are larger than other markets.

7. The method of claim 2 wherein one of the constraints constrains the objective function to generate resource allocations that are substantially equal for all items whose resource allocations are determined by the optimization function to be greater than zero.

8. The method of claim 2 wherein one of the constraints constrains the objective function to maximize the return on equity.

9. The method of claim 2 wherein the cross-selling opportunities metric includes an effort cross-selling opportunities metric which solves the business issue, wherein the business issue is directed to the resource allocation that maximizes return on investment related to the purchasing of the second set of items.

10. The method of claim 1 wherein the cross-selling relationships include association rules, wherein the association rules have left-hand-side items and right-hand-side items.

11. The method of claim 10 wherein the cross-selling statistic is a lift cross-selling statistic.

12. The method of claim 11 wherein the lift cross-selling statistic is ratio of the probability of having the right-hand-side items given that a customer has the left-hand-side items, over the probability that the customer has the right-hand-side items.

13. The method of claim 11 wherein the cross-selling statistic further includes an expected confidence cross-selling statistic that indicates the frequency with which the right-hand-side items occurs in the overall population of the first and second set of items.

14. The method of claim 1 wherein the first and second set of items include products to be purchased by customers.

15. The method of claim 1 wherein the first and second set of items include services to be purchased by customers.

16. The method of claim 1 wherein the cross-selling relationships and cross-selling statistic are generated from a data miner based upon historical data on sales related to the first and second sets of items.

17. A computer-implemented system for solving a business issue related to resource allocation involved in cross-selling opportunities, comprising:
an association rules data store to store cross-selling relationships that associate the purchase of a first set of items with the purchase of a second set of items;
said cross-selling relationships being associated with a cross-selling statistic, wherein the cross-selling statistic is indicative of the potential for purchase of the second set of items based upon the purchase of the first set of items; and
an optimization module connected to the association rules data store and containing at least one constraint related to the business issue,
wherein the optimization module determines resource allocation for a business operation related to the purchase of the second set of items, said determining being performed based upon the cross-selling relationships, the cross-selling statistic, and the business issue constraint.

18. The system of claim 17 wherein the optimization module is a linear programming module that includes an objective function, wherein the objective function is solved for the resource allocation related to the purchase of the second set of items.

19. The system of claim 17 wherein one of the constraints is based upon target effort for an item.

20. The system of claim 17 wherein one of the constraints is directed to size of markets involving the first and second sets of items.

21. The system of claim 17 wherein one of the constraints is directed to size of markets involving the first and second sets of items such that resource allocation is biased towards markets that are larger than other markets.

22. The system of claim 18 wherein one of the constraints constrains the objective function to generate resource allocations that are substantially equal for all items whose resource allocations are determined by the optimization function to be greater than zero.

23. The system of claim 18 wherein one of the constraints constrains the objective function to maximize the return on equity.

24. The system of claim 17 wherein the cross-selling opportunities metric includes an effort cross-selling opportunities metric which solves the business issue, wherein the business issue is directed to the resource allocation that maximizes return on investment related to the purchasing of the second set of items.

25. The system of claim 17 wherein the cross-selling relationships include association rules, wherein the association rules have left-hand-side items and right-hand-side items.

26. The system of claim 25 wherein the cross-selling statistic is a lift cross-selling statistic.

27. The system of claim 26 wherein the lift cross-selling statistic is ratio of the probability of having the right-hand-side items given that a customer has the left-hand-side items, over the probability that the customer has the right-hand-side items.

28. The system of claim 26 wherein the cross-selling statistic is an expected confidence cross-selling statistic that indicates the frequency with which the right-hand-side items occurs in the overall population of the first and second set of items.

29. The system of claim 17 wherein the first and second set of items include products to be purchased by customers.

30. The system of claim 17 wherein the first and second set of items include services to be purchased by customers.

31. The system of claim 1 wherein the cross-selling relationships and cross-selling statistic are generated from a data miner based upon historical data on sales related to the first and second sets of items.

32. A computer-implemented cross-selling analysis system, comprising:
computer data storage means for storing association rules that associate purchases of a first set of items with purchases of a second set of items;
said association rules being associated with a lift cross-selling statistic, said lift cross-selling statistic being indicative of potential for the purchase of the second set of items based upon the purchase of the first set of items;
constraints storage means for storing constraints related to achieving a predetermined business goal; and
optimization means connected to the computer data storage and to the constraints storage means,
said optimization means containing an objective function that determines the amount of effort to be used in the selling of the items by substantially maximizing the predetermined business goal subject to the constraints, the association rules, and the lift cross-selling statistic.
